(19) United States
(12) Patent Application Publication
(10) Pub. No.: US 2012/0195345 A1
(43) Pub. Date: Aug. 2, 2012

(54) LCD SCREEN FOR THERMOMETER

(76) Inventor: Hsueh-Yu Lu, Taoyuan (TW)

(21) Appl. No.: 13/017,047

(22) Filed: Jan. 30, 2011

(51) Int. Cl. G01K 7/00

(52) U.S. Cl. 374/170; 374/E07.001

(57) ABSTRACT

A LCD screen used in a thermometer for displaying the body temperature of a person measured by the thermometer, having a center temperature-display zone adapted for displaying a front part of the digits of the temperature value measured by the thermometer, and an outer temperature-display zone surrounding the center temperature-display zone adapted for displaying the last digit, for example, the digit at the tenths or hundredths place after the decimal point of the temperature value measured by the thermometer by means of one of the digital numerals 0˜9.

### BACKGROUND OF THE INVENTION

1. Field of the Invention

The present invention relates to a thermometer for clinical application and more particularly, to a LCD screen used in a thermometer, which enables the last digit of the temperature value measured by the thermometer to be separately displayed in a separate display zone, so that the user can read the measured data easily and accurately, avoiding a reading error.

2. Description of the Related Art

Many electronic thermometers, thermocouples and infrared thermometers are commercially available. These body temperature measuring implements are inexpensive and easy to use. Therefore, most families and companies have an electronic body temperature measuring implement for use when necessary. Further, conventional electronic body temperature measuring implements commonly use a digital display device, i.e., 7-segment display device to display the measured body temperature value. However, the decimal fraction of the displayed body temperature value is monotonous, inactive and not outstanding, it may be not accurately read by the user of the electronic body temperature measuring implements.

### SUMMARY OF THE INVENTION

The present invention has been accomplished under the circumstances in view. It is one object of the present invention to provide a LCD screen for thermometer, which enables the last digit of the temperature value measured by the thermometer to be separately displayed in a separate display zone, so that the user can read the measured data easily and accurately, avoiding a reading error.

To achieve this and other objects of the present invention, a LCD screen is used in a thermometer for displaying the body temperature of a person measured by the thermometer, having a center temperature-display zone adapted for displaying a front part of the series of digits of the temperature value measured by the thermometer, and an outer temperature-display zone surrounding the center temperature-display zone adapted for displaying the last digit, for example, the digit at the tenths or hundredths place after the decimal point of the temperature value measured by the thermometer by means of one of the digital numerals 0˜9.

### BRIEF DESCRIPTION OF THE DRAWINGS

FIG. 1 illustrates the outer appearance of a thermometer with a LCD screen in accordance with the present invention.

FIG. 2 is a schematic front view of a LCD screen in accordance with the present invention.

FIG. 3 is a schematic front view of an alternate form of the LCD screen in accordance with the present invention.

FIG. 4 is a circuit diagram of the control module used in the thermometer shown in FIG. 1.

FIG. 5 illustrates a display mode of the LCD screen in accordance with the present invention.

FIG. 6 illustrates another display mode of the LCD screen in accordance with the present invention.

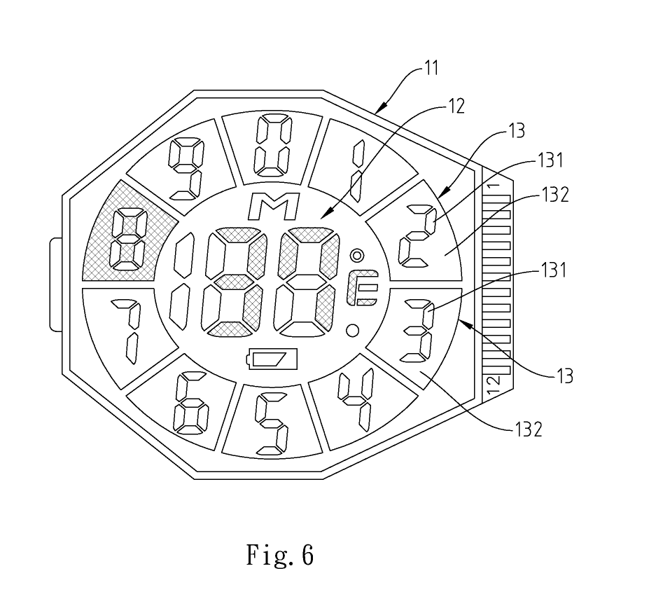

### DETAILED DESCRIPTION OF THE PREFERRED EMBODIMENT

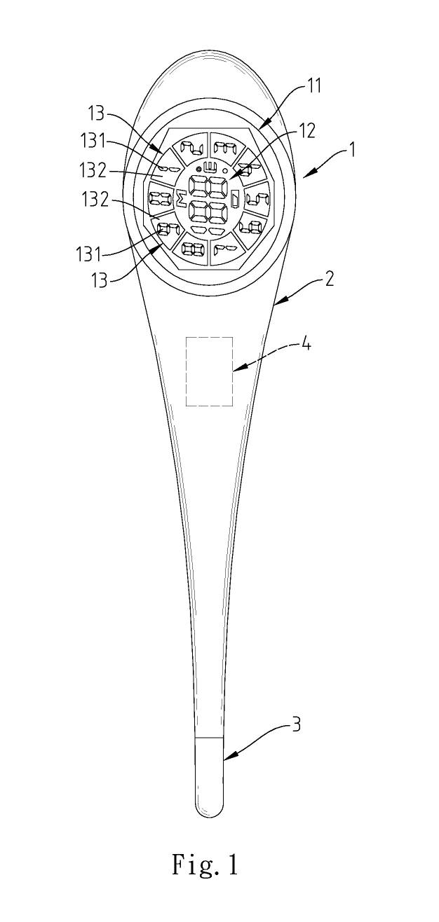

Referring to FIGS. 1˜4, a thermometer 1 is shown comprising a housing 2, a metal temperature sensing probe 3 located on one end of the housing 2, a LCD screen 11 located on one side of the housing 2 and a control module 4 mounted inside the housing 2 and electrically connected with the metal temperature sensing probe 3 and the LCD screen 11.

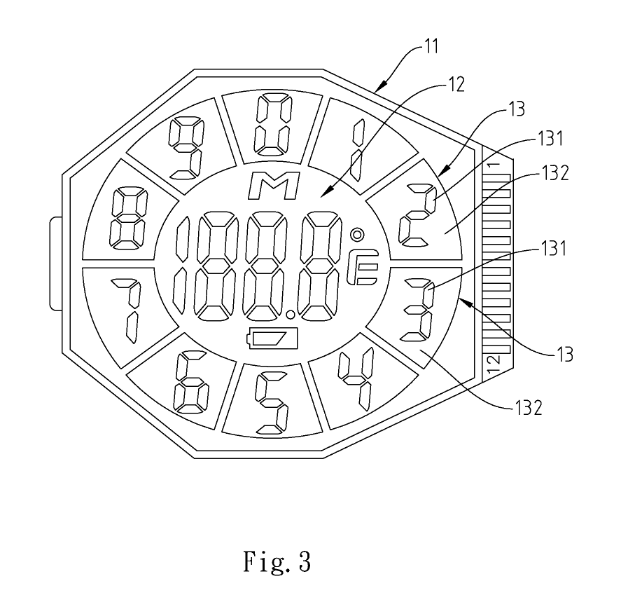

The control module 4 can be a circuit. As shown in FIG. 3, the LCD screen 11 defines a center temperature-display zone 12 and an outer temperature-display zone 13 surrounding the center temperature-display zone 12. The center temperature-display zone 12 is adapted for displaying a front part of the series of digits of the temperature value measured by the thermometer 1. The outer temperature-display zone 13 defines a plurality of numeral-display sub-zones 131 and background-display sub-zones 132, and adapted for displaying the digits 0˜9, other patterns, symbols or marks respectively. Further, the outer temperature-display zone 13 is adapted for displaying the last digit of the temperature value measured by the thermometer 1, for example, the digit at the tenths place after the decimal point of the temperature value measured by the thermometer 1, or the digit at the hundredths place after the decimal point of the temperature value measured by the thermometer 1. Further, the outer temperature-display zone 13 can be arranged into an annular, rectangular or triangular shape or any other profile surrounding the center temperature-display zone 12.

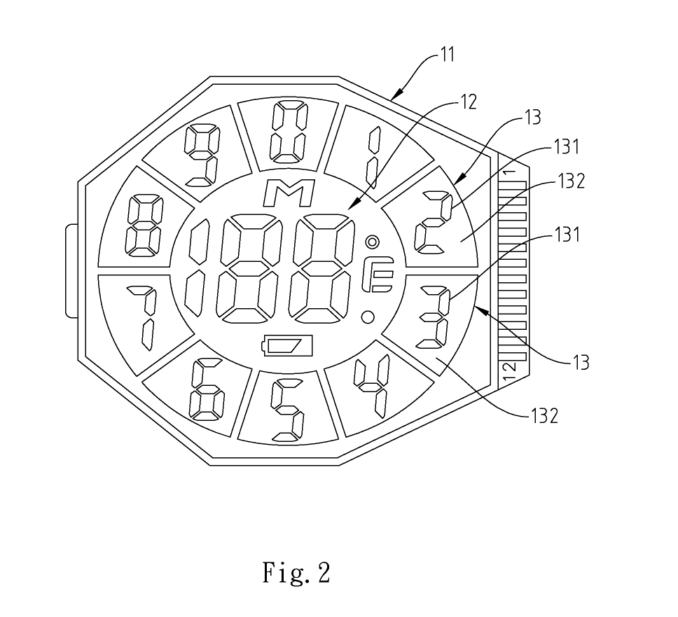

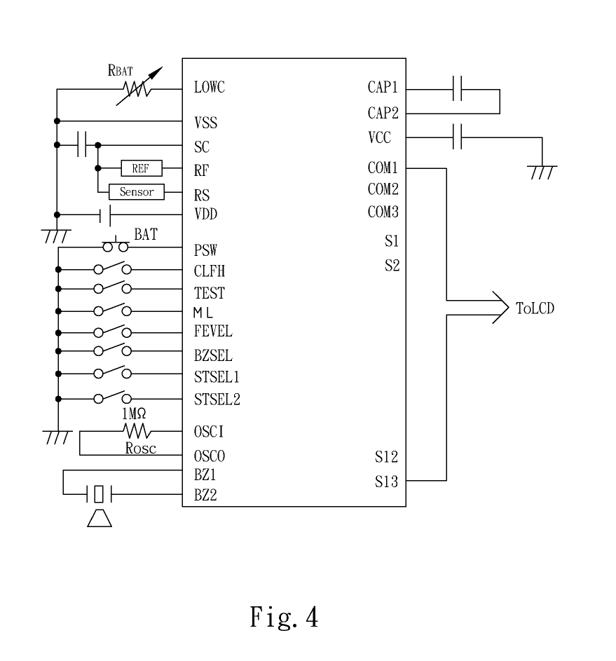

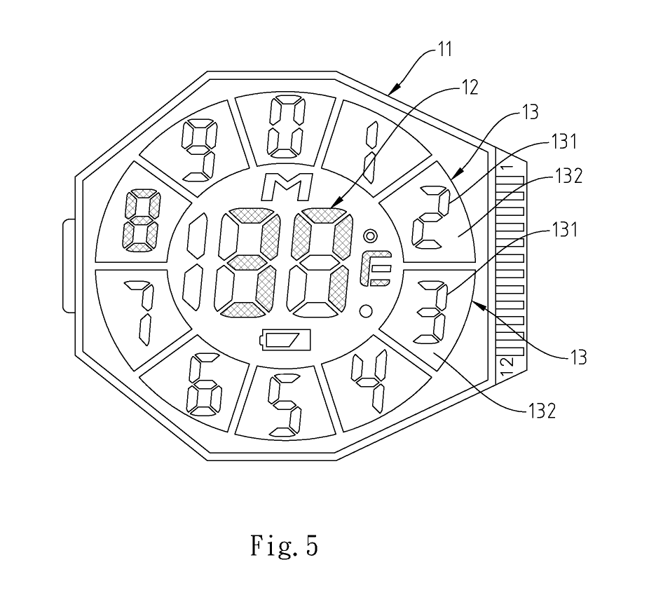

Referring to FIG. 5 and FIGS. 1-4 again, when using the thermometer 1, the metal temperature-sensing probe 3 is held in contact with the user's body, enabling the user's body temperature to be transferred to the metal temperature-sensing probe 3 and then the control module 4. At this time, the control module 4 converts the detected analog temperature signal into a digital temperature-value signal and sends the digital temperature-value signal to the LCD screen 11 for display. At this time, the control module 4 controls the center temperature-display zone 12 to display the front part of the series of digits of the digital temperature value, for example, the digits before the decimal point, and the outer temperature-display zone 13 to display the last digit of the digital temperature value, for example, the digit at the tenths place after the decimal point of the temperature value measured by the thermometer 1, or the digit at the hundredths place after the decimal point of the digital temperature value. When the outer temperature-display zone 13 is displaying the last digit of the digital temperature value, the corresponding numeral-display sub-zone 131 becomes light-tight (or turned off) and the associating background-display sub-zones 132 becomes light transmissive (or turned on). In an alternate form of the present invention, when the outer temperature-display zone 13 is displaying the last digit of the digital temperature value, the corresponding numeral-display sub-zone 131 becomes light-transmissive (or turned on) and the associating background-display sub-zones 132 becomes light-tight (or turned off).

Thus, when the user can read the temperature value displayed on the LCD screen 11 easily and accurately, avoiding a reading error.

Further, when the user turns on the thermometer 1, the numeral-display sub-zones 131 (or background-display sub-zones 132) of the outer temperature-display zone 13 will be turned on to show the digits 0˜9, other patterns, symbols or marks, and then turned off after display of all the digits 0˜9. Thus, the user can visually check normal functioning of the LCD screen 11.

Alternatively, the thermometer 1 can be so made that, when the user turns on the thermometer 1, the numeral-display sub-zones 131 (or background-display sub-zones 132) of the outer temperature-display zone 13 will be flashed one after another to show the digits 0˜9, other patterns, symbols or marks in sequence. Thus, the user can visually check normal functioning of the LCD screen 11.

Although particular embodiment of the invention have been described in detail for purposes of illustration, various modifications and enhancements may be made without departing from the spirit and scope of the invention. Accordingly, the invention is not to be limited except as by the appended claims.

What the invention claimed is:

1. A LCD screen used in a thermometer for displaying the body temperature of a person measured by said thermometer, comprising a center temperature-display zone adapted for displaying a front part of the series of digits of the temperature value measured by said thermometer, and an outer temperature-display zone surrounding said center temperature-display zone adapted for displaying the last digit of the temperature value measured by said thermometer by means of one of the digital numerals 0-9.

2. The LCD screen as claimed in claim 1, wherein the last digit to be displayed by said outer temperature-display zone is the digit at the tenths place after the decimal point of the temperature value measured by said thermometer.

3. The LCD screen as claimed in claim 1, wherein the last digit to be displayed by said outer temperature-display zone is the digit at the hundredths place after the decimal point of the temperature value measured by said thermometer.

4. The LCD screen as claimed in claim 1, wherein said outer temperature-display zone has an annular configuration surrounding said center temperature-display zone.

5. The LCD screen as claimed in claim 1, wherein said thermometer comprises a housing carrying said LCD screen, a metal temperature sensing probe located on one end of said housing and adapted for sensing the body temperature of a human being, and a control module mounted inside said housing and electrically connected with said metal temperature sensing probe and said LCD screen and adapted for processing the signal sensed by said metal temperature sensing probe and controlling said LCD screen to display the processed data.

6. The LCD screen as claimed in claim 1, wherein said outer temperature-display zone defines a plurality of numeral-display sub-zones and a plurality of background-display sub-zones corresponding to said numeral-display sub-zones.

7. The LCD screen as claimed in claim 6, wherein when said outer temperature-display zone is controlled by said control module to display the last digit of the temperature value measured by said thermometer, one numeral-display sub-zone is turned on and the associating said background-display sub-zone is turned off.

8. The LCD screen as claimed in claim 6, wherein when said outer temperature-display zone is controlled by said control module to display the last digit of the temperature value measured by said thermometer, one numeral-display sub-zone is turned off and the associating said background-display sub-zone is turned on.

9. The LCD screen as claimed in claim 1, wherein when said thermometer is turned on, said outer temperature-display zone is initialized to display the digits 0-9 for a predetermined length of time.

10. The LCD screen as claimed in claim 1, wherein when said thermometer is turned on, said outer temperature-display zone is initialized to flash the digits 0-9 one after another in sequence
